(19) United States
(12) Patent Application Publication
(10) Pub. No.: US 2009/0185578 A1
(43) Pub. Date: Jul. 23, 2009

(54) METHOD, APPARATUS AND SYSTEM FOR TRANSMITTING FIBER CHANNEL SERVICE

(76) Inventor: Li ZENG, Shenzhen (CN)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/415,456

(22) Filed: Mar. 31, 2009

Related U.S. Application Data
(63) Continuation of application No. PCT/CN2007/071024, filed on Nov. 6, 2007.

(30) Foreign Application Priority Data
Nov. 6, 2006 (CN) 200610137846.5

(51) Int. Cl. H04L 29/06; H04J 14/00

(52) U.S. Cl. 370/466; 370/476; 398/43

(57) ABSTRACT

The present invention provides an apparatus and system for transmitting fiber channel services. The apparatus includes an FC service transmission module, a mapping module, a label adding module, an FC service receiving module, a label removing module, and a demapping module. In the embodiments of the present invention, transport channel labels are added for FC services, and FC services are multiplexed into a packet physical interface. Thus, FC services can be transmitted in the packet switched network transparently. Besides, FC services are loaded into the Ethernet payload so that there is no need to generate a GFP idle frame to adapt to the Ethernet payload, thus simplifying the process.

### CROSS-REFERENCE TO RELATED APPLICATIONS

This application is a continuation of international application number PCT/CN2007/071024, filed on Nov. 6, 2007, which claims the benefit of priority from the Chinese Patent Application No. 200610137846.5, filed with the Chinese Patent Office on Nov. 6, 2006, both of which are incorporated herein by reference in their entirety.

### TECHNICAL FIELD

The present invention relates to optical communications, and in particular, to a method, apparatus and system for transmitting fiber channel services.

### BACKGROUND

The Generic Framing Procedure (GFP) is an encapsulation technology, and can be adapted to encapsulate various data services, including Ethernet, Multiple Protocol Label Switching (MPLS), Internet Protocol (IP), and Fiber Channel (FC) services. Frames encapsulated by the GFP are mapped onto virtual containers of Synchronous Digital Hierarchy (SDH)/Optical Transport Network (OTN) and thereby data services are transmitted. The GFP has two encapsulation modes: GFP framing (GFP-F) mode and GFP transparent (GFP-T) mode. The GFP-T mode may be applicable to layer 2 data services of 8B/10B codes, such as Gigabit Ethernet (GE) and FC services, and may also provide a low delay encapsulation based on byte encapsulation of physical codes. FIG. 1 shows the structure of a GFP frame. As shown in FIG. 1, the GFP core frame header has four bytes and includes a 16-bit payload length indication (PLI) and a 16-bit core frame header error check; the GFP payload area includes all bytes except the GFP core frame header, and is adapted to transfer upper-layer client information, with a variable length of 4 to 65535 bytes. The GFP payload area includes a payload frame header, a payload information field and an optional payload frame check sequence field, where the payload frame header is a field with a variable length of 4 to 64 bytes and manages data links related to client signals, and the payload information field may carry frame-mapped protocol data units (PDU) or transparent-mapped client signal characters.

An FC interface is a standard interface for a storage area network (SAN). The SAN is a private high-speed data storage network, and connects multiple independent storage systems to multiple servers by using fiber channel switches and other switching devices. With the increasing requirements for data security and data sharing, multiple SAN networks in different locations need to be interconnected for redundancy backup and data integration. Thus, it is necessary to connect the FC service interface to a transport network for transparent transmission. Due to growing data services in the transport network, the platform is changed from the former SDH platform that supports voice transmission to the multiple service transport platform (MSTP) that supports multiple service transmission. The current MSTP, however, is still based on the SDH, as shown in FIG. 2.

As shown in FIG. 3, the FC-BB-3_GFPT over SDH performs GFP encapsulation on FC services, and transmits the FC services through the SDH or OTN network. The FC services from an FC device must be processed by the FC-0/FC-1 interface and FC-BB-3_GFPT processing module, which mainly perform the FC control protocol and GFP encapsulation. The FC control protocol includes interface negotiation and remote flow control. The FC-BB-3_GFPT protocol state machine initializes the FC interface connection and establishes the connection. It monitors FC protocol control frames such as ELP, FLOGI, PLOGI, SW_ACC, and LS_ACC, and changes control frame parameters for transmission to the wide area network (WAN) so as to perform effective flow control on the FC services in the WAN. After being processed by the FC-BB-3_GFPT protocol state machine, the physical codes of the FC services are encapsulated into a GFP frame. The GFPT processing unit encapsulates the physical code frames of the FC by every 8 bytes (totally 64 bits), including a data word and a control word, according to the 64B/65B code format. Eight 65B code blocks and 16-bit frame check sequence (FCS) form a super block. N super blocks are encapsulated as a payload information field into a GFP frame to form GFPT encapsulation, where N depends on the basic rate of a client signal and the capacity of a transport channel. The GFP frame is mapped to an SDH virtual container to transmit large bandwidth services in a virtual concatenation mode or in a concatenation mode. When the GFP frame is mapped to an SDH virtual container, rate adaptation needs to be implemented through a GFP idle frame so as to ensure that the GFP service frame rate is consistent with that of the SDH virtual container. This technology multiplexes the FC services into the SDH. Because the FC services are data services with a large bandwidth, it is necessary to adopt a complex virtual concatenation technology to multiplex the FC services into the SDH virtual container, making the implementation more difficult. With the development of IP-based services, a multiple service transport platform based on packet technologies may be the next generation transport platform, such as provider backbone transport (PBT) and MPLS. With the development of packet transport networks, the SDH-based transport technology may disappear.

As shown in FIG. 4, the FC over Pseudo Wire Emulation Edge-to-Edge (PWE3) means that the FC services are transported in a packet network after undergoing PW encapsulation. First, a native service processing (NSP) module processes an input FC service, for example, registering the FC connection, responding to the local FC flow control, and processing the remote FC flow control. An FC-2 frame is obtained, and then PW encapsulation is performed on the FC-2 frame to form a PW service. The PW service is multiplexed into a transport tunnel and enters a packet switched network (PSN). In this scheme, the PW encapsulation is required for the FC services, and the FC physical layer control information is composed of special characters of 8B/10B codes. However, the PW encapsulation terminates the FC physical layer control information while performing transparent transmission of the FC-2 frame. Thus, the FC physical layer control information cannot be transmitted transparently. To transmit the FC physical layer control information transparently, the NSP module is required to convert the control information into special codes and identify the control information. This greatly increases the complexity of the NSP module. Besides, the FC-2 frame needs to carry a PW label and an MPLS label so that the FC-2 frame can be multiplexed into an Ethernet frame for transmission. The maximum length of an FC-2 frame is 2148 bytes, but the suggested maximum length for a frame in the Ethernet is 1518 bytes. Thus, the PW packet that encapsulates the FC services fails to meet this requirement, and needs to be fragmented. That is, the FC-2 frame is divided into two packets for transmission, thus increasing the complexity of the PW encapsulation.

### SUMMARY

The embodiments of the present disclosure provide a method, apparatus and system for transmitting FC services on a PSN by adding a transport channel label to a GFP frame and multiplexing the GFP frame into a packet physical interface.

The embodiments of the present disclosure provide the following technical scheme:

A method for transmitting FC services includes:
by an FC service transmitting end, mapping an FC service to a transparently encapsulated code block; and
adding a transport channel label to the transparently encapsulated code block, and loading the transparently encapsulated code block into an Ethernet payload for transmission in a packet transport network.

A method for transmitting FC services includes:
by an FC service receiving end, receiving an Ethernet payload from a packet transport network, and removing a transport channel label from the Ethernet payload to obtain a transparently encapsulated code block; and
demapping the obtained transparently encapsulated code block to obtain an FC service.

A system for transmitting FC services includes:
an FC service transmission module, adapted to transmit an FC service;
a mapping module, adapted to receive the FC service from the FC service transmission module, map the FC service to a transparently encapsulated code block, and transmit the transparently encapsulated code block;
a label adding module, adapted to receive the transparently encapsulated code block from the mapping module, add a transport channel label to the transparently encapsulated code block, and load the transparently encapsulated code block to an Ethernet payload for transmission in a packet transport network;
an FC service receiving module, adapted to receive the Ethernet payload transmitted in the packet transport network, and forward the Ethernet payload;
a label removing module, adapted to receive the Ethernet payload from the FC service receiving module, remove the transport channel label from the Ethernet payload, and extract the transparently encapsulated code block for transmission; and
a demapping module, adapted to receive the transparently encapsulated code block from the label removing module, and demap the transparently encapsulated code block to obtain the FC service.

An apparatus for transmitting FC services includes:
an FC service transmission module, adapted to transmit an FC service;
a mapping module, adapted to receive the FC service from the FC service transmission module, map the FC service to a transparently encapsulated code block, and transmit the transparently encapsulated code block; and
a label adding module, adapted to receive the transparently encapsulated code block from the mapping module, add a transport channel label to the transparently encapsulated code block, and load the transparently encapsulated code block to an Ethernet payload for transmission in a packet transport network.

An apparatus for receiving FC services includes:
an FC service receiving module, adapted to receive an Ethernet payload transmitted in a packet transport network, and forward the Ethernet payload;
a label removing module, adapted to receive the Ethernet payload from the FC service receiving module, remove a transport channel label from the Ethernet payload, and extract the transparently encapsulated code block for transmission; and
a demapping module, adapted to receive the transparently encapsulated code block from the label removing module, and demap the transparently encapsulated code block to obtain an FC service.

The embodiments of the present disclosure have the following benefits:

1. Because a transport channel label is added, and the FC services are multiplexed into a packet physical interface, the FC services can be transparently transmitted in the PSN.

2. Because the FC services are loaded in the Ethernet payload, it is unnecessary to generate a GFP idle frame to adapt to the Ethernet payload, thus simplifying the process.

### BRIEF DESCRIPTION OF THE DRAWINGS

FIG. 1 shows the structure of a GFP frame in the prior art;

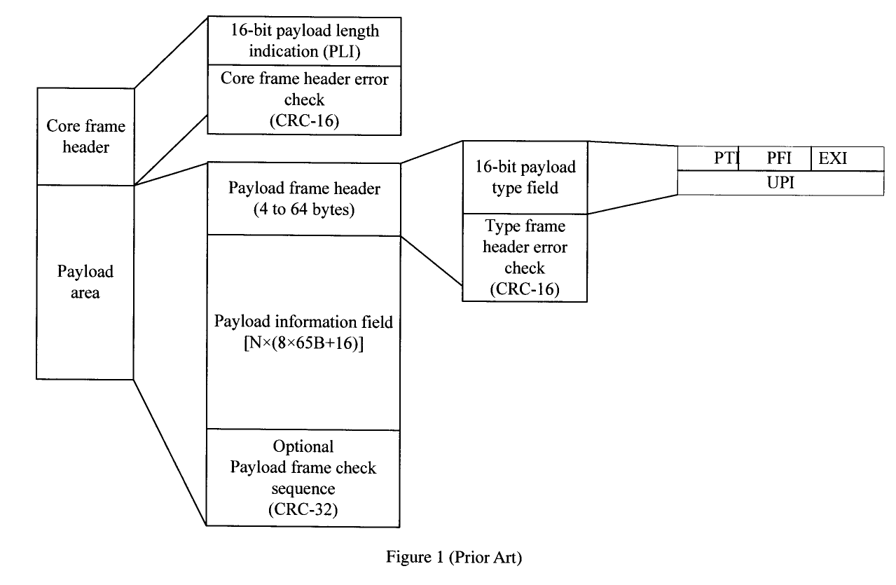

FIG. 2 shows the process of transmitting FC services in an SDH or OTN network in the prior art;

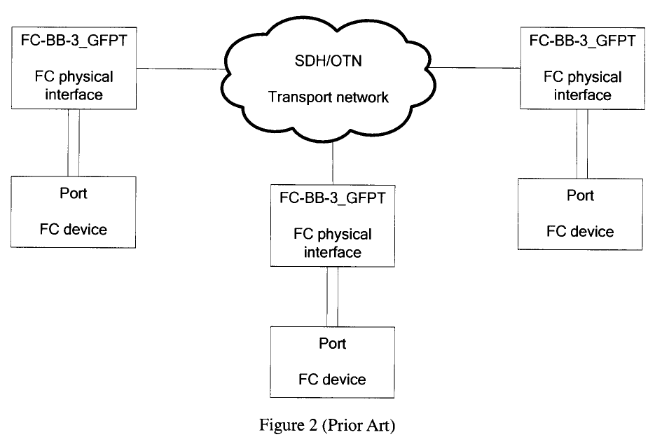

FIG. 3 shows the process of performing GFP encapsulation on FC services and transmitting the FC services in an SDH or OTN network in the prior art;

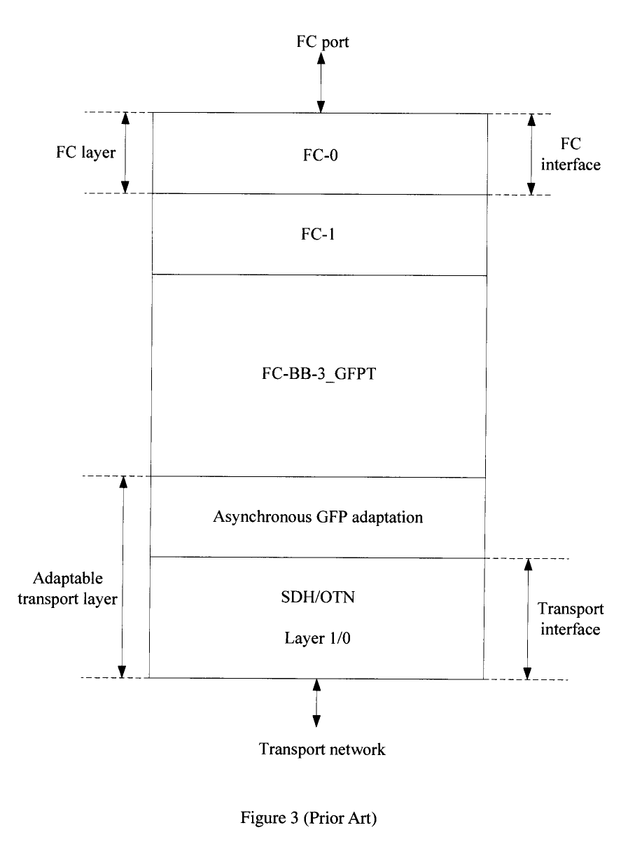

FIG. 4 shows the process of performing PW encapsulation on FC services and transmitting the FC services in an SDH or OTN network in the prior art;

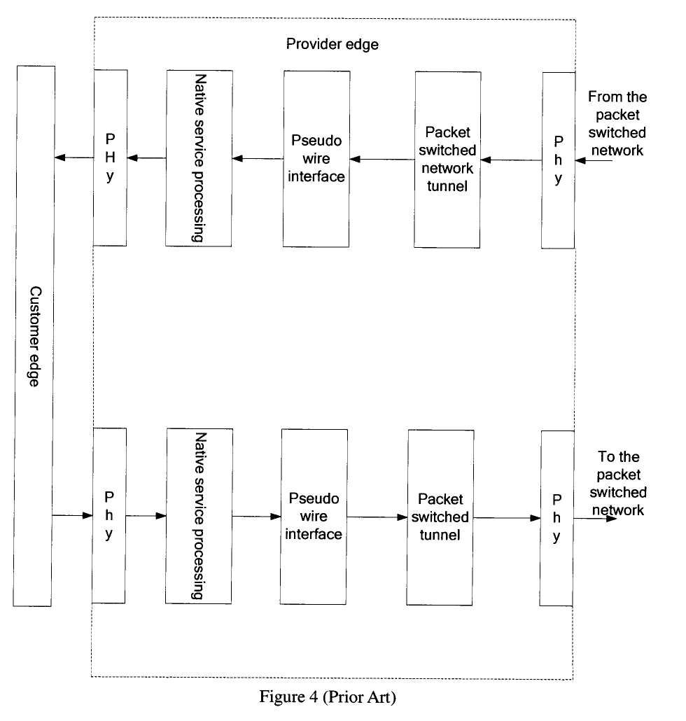

FIG. 5 shows the process of mapping FC services to a packet transport network according to an embodiment of the present disclosure;

FIG. 6 shows the process of mapping a GFP frame to a transparently encapsulated code block according to an embodiment of the present disclosure;

FIG. 7 shows the flowchart of a first embodiment of the present disclosure;

FIG. 8 shows the process of mapping an FC physical layer signal to a transparently encapsulated code block according to an embodiment of the present disclosure;

FIG. 9 shows the flowchart of a second embodiment of the present disclosure;

FIG. 10 shows the flowchart of a third embodiment of the present disclosure; and

FIG. 11 shows the structure of an apparatus for transmitting FC services according to an embodiment of the present disclosure.

### DETAILED DESCRIPTION OF THE EMBODIMENTS

The present invention is hereinafter described in detail with reference to the accompanying drawings and exemplary embodiments, but the embodiments are not intended to limit the present invention.

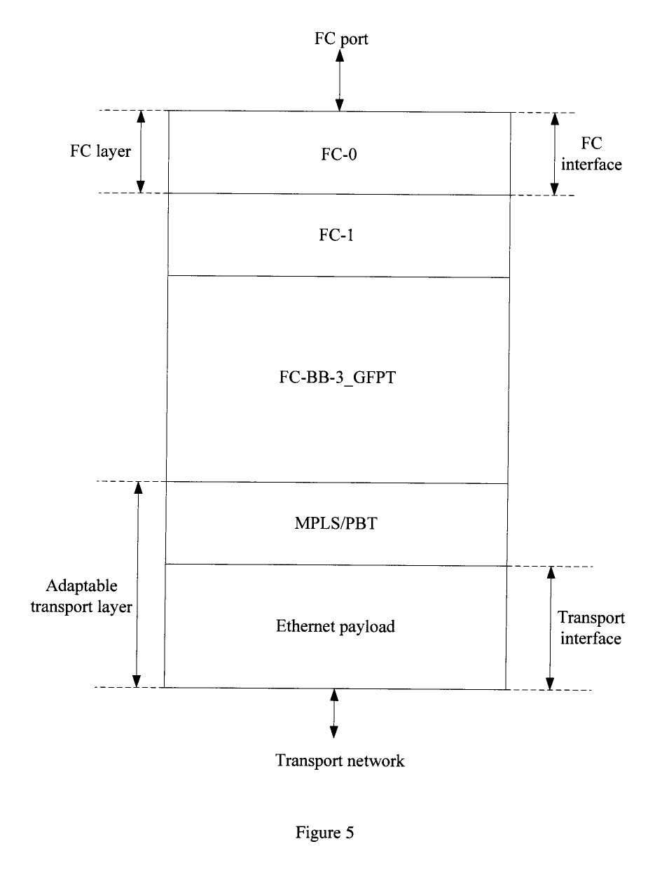

As shown in FIG. 5, an embodiment of the present disclosure provides a method for transmitting FC services transparently in a packet transport network, in which an FC service is encoded to form a transparently encapsulated code block, and then multiplexed into a packet physical interface after a transport channel label is added. The following describes the embodiments of the present disclosure in detail, providing, as an example, that the PSN is an MPLS network.

### Embodiment 1

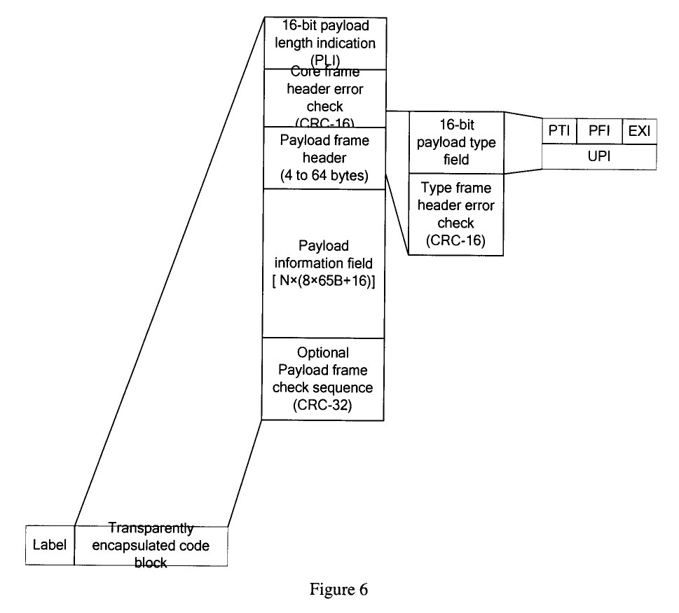

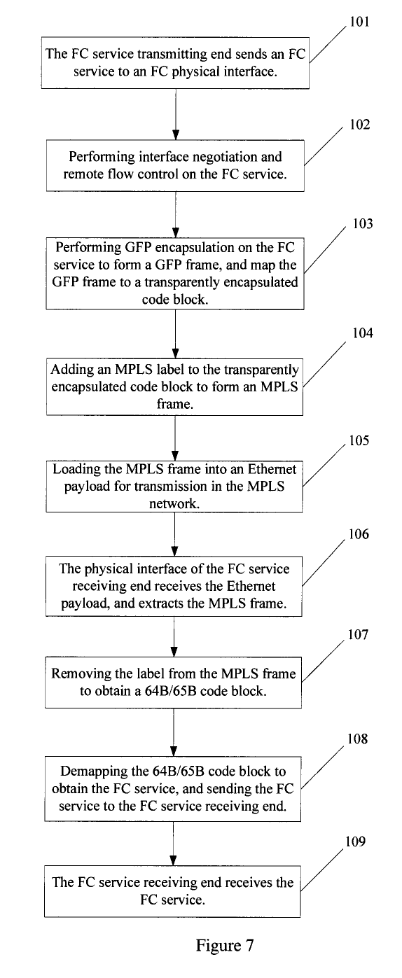

As shown in FIGS. 5 to 7, the process of transmitting FC services in an MPLS packet transport network includes the following steps:

Step 101: The FC service transmitting end transmits an FC service to an FC physical interface.

Step 102: After receiving the FC service, the FC physical interface performs interface negotiation and remote flow control on the FC service.

Step 103: Performing 64B/65B encoding on the processed FC service to form a 64B/65B code block, performing GFP encapsulation on the 64B/65B code block to form a GFP frame, and mapping the GFP frame to a transparently encapsulated code block.

Step 104: Adding an MPLS label to the transparently encapsulated code block, and inserting a stack bottom flag to form an MPLS frame.

Because the FC service is transmitted in the MPLS packet network, which uses a label switching path to identify a packet transport channel, an MPLS label may be added to the transparently encapsulated code block.

Step 105: Loading the MPLS frame to an Ethernet payload, and sending the Ethernet payload to the MPLS network for transmission.

Because the GFP frame is mapped to the Ethernet payload in a frame-by-frame way, and rate adaptation is available during the transmission of the Ethernet payload, it may not be necessary to generate a GFP idle frame to adapt to the Ethernet payload when a label is added to the GFP frame and the GFP frame is mapped to the Ethernet payload, thus simplifying the adaptation and mapping.

Step 106: The physical interface of the FC service receiving end receives the Ethernet payload, and extracts an MPLS frame from the Ethernet payload.

Step 107: Removing the label from the MPLS frame to obtain a 64B/65B code block.

Step 108: Demapping the 64B/65B code block to obtain an FC service signal, and sending the FC service signal to the FC service receiving end.

Because a label is added to GFP frames one by one, it may not be necessary to delimit a frame header for each GFP frame when the WAN receiving end recovers the GFP frame in the Ethernet payload. In this way, when the FC service receiving end receives the GFP frame, the core header error check may be simplified, without the necessity of frame delimitation.

Step 109: The FC service receiving end receives the FC service from the FC service transmitting end.

### Embodiment 2

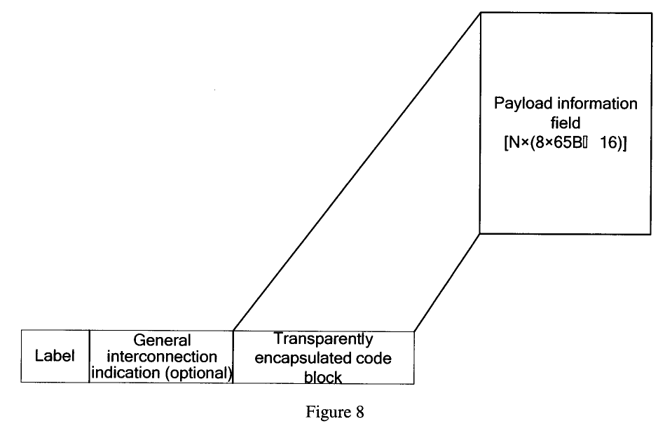

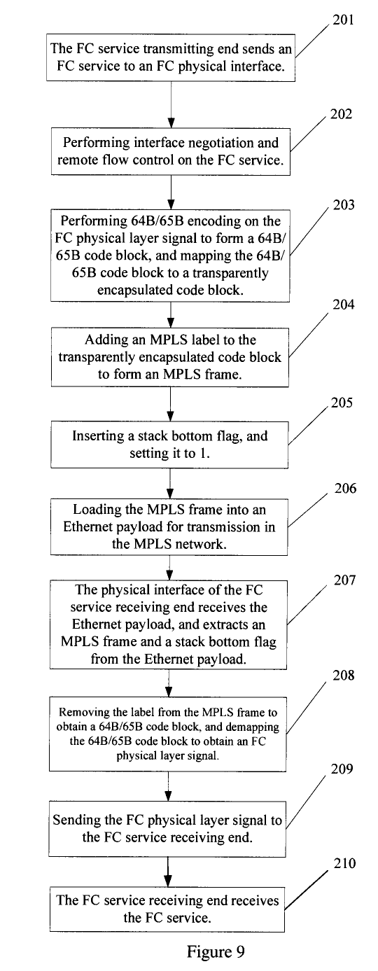

As shown in FIG. 8 and FIG. 9, the GFP frames of transparently transmitted FC services are mapped to Ethernet payloads one by one. Thus, the 64B/65B code block is directly mapped to an Ethernet payload without processing the core frame header and payload frame header. In this case, the process of transmitting FC services in an MPLS packet transport network includes the following steps:

Step 201: The FC service transmitting end transmits an FC service to an FC physical interface.

Step 202: After receiving the FC service, the FC physical interface performs interface negotiation and remote flow control on the FC service.

Step 203: Performing 64B/65B encoding on the processed FC physical layer signal to form a 64B/65B code block, and mapping the 64B/65B code block to a transparently encapsulated code block.

Step 204: Adding an MPLS label to the transparently encapsulated code block to form an MPLS frame.

Step 205: Inserting a one-bit stack bottom flag according to the MPLS protocol, and setting the stack bottom flag to 1.

If the stack bottom flag is 1, the client signal is not MPLS.

Step 206: Loading the MPLS frame to an Ethernet payload, and sending the Ethernet payload to the MPLS network for transmission.

Step 207: The physical interface of the FC service receiving end receives the Ethernet payload, and extracts the MPLS frame and stack bottom flag from the Ethernet payload.

Step 208: Removing the label from the MPLS frame to obtain a 64B/65B code block, and demapping the 64B/65B code block to obtain an FC physical layer signal.

Step 209: Sending the FC physical layer signal to the FC service receiving end.

Step 210: The FC service receiving end receives the FC service from the FC service transmitting end.

In this embodiment, a step of inserting a general interconnection indication CII field may be added between Step 204 and Step 205, which may prevent sequence error in packet forwarding. Accordingly, a step of extracting the general interconnection indication CII field and processing the sequence number field may be added between Step 207 and Step 208.

### Embodiment 3

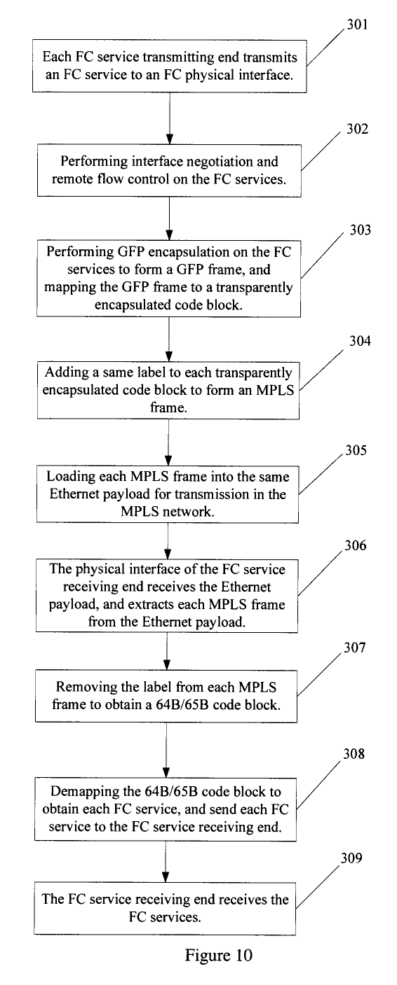

As shown in FIG. 5 and FIG. 10, the method provided by an embodiment of the present disclosure is also applicable to loading multiple FC services into an MPLS channel. When multiple FC services are mapped to a transport channel for transmission in a packet network, each FC service needs to be identified so that the FC services can be isolated from each other during the transmission. When the GFP encapsulation is performed on the FC services, the rich overheads in the GFP format may be used to identify channels of multiple FC services. More particularly, the following two modes may be available:

1. Setting the extended field EXI in the payload frame header to 001. That is, EXI=001.Table 1 below shows the format of the payload frame header of a GFP frame.

TABLE 1

16 bit payload type field (EXI = 001)
16-bit type frame header error check (tHEC)
16-bit channel identifier (CID)
16-bit extended frame header error check (eHEC)

2. Using the payload length indication (PLI) field.

Because a label is added to GFP frames one by one, and each GFP frame is mapped to the MPLS transport channel, the frame delimitation may be implemented at the packet physical interface when the GFP frame is extracted. Thus, it may not be necessary to re-delimit the GFP frame. The PLI field in the core frame header may be used for channel identification. Table 2 below shows the format of the core frame header of a GFP frame.

TABLE 2

16-bit channel identifier (CID)
16-bit core frame header error check (cHEC)

The process of transmitting multiple FC services in an MPLS packet transport network by using the preceding two modes includes the following steps:

Step 301: Each FC service transmitting end transmits an FC service to an FC physical interface.

Step 302: After receiving the FC service, each FC physical interface performs interface negotiation and remote flow control on the FC service.

Step 303: Performing 64B/65B encoding on the processed FC service to form a 64B/65B code block, performing GFP encapsulation on the 64B/65B code block to form a GFP frame, and mapping the GFP frame to a transparently encapsulated code block.

Step 304: Adding a same MPLS label to each transparently encapsulated code block to form the same MPLS frame.

Because the FC services are transmitted in the MPLS packet network, which use a label switching path to identify a packet transport channel, an MPLS label may be added to the transparently encapsulated code block. Adding a same MPLS label to each transparently encapsulated code block may save the limited number of MPLS labels.

Step 305: Loading each MPLS frame to the same Ethernet payload, and sending the Ethernet payload to the MPLS network for transmission.

Because the GFP frame is mapped to the Ethernet payload, and rate adaptation is available during the transmission of the Ethernet payload, it may be unnecessary to generate a GFP idle frame to adapt to the Ethernet payload when a label is added to the GFP frame and the GFP frame is mapped to the Ethernet payload, thus simplifying the adaptation and mapping.

Step 306: The physical interface of the FC service receiving end receives the Ethernet payload, and extracts each MPLS frame from the Ethernet payload.

Step 307: Removing the label from each MPLS frame to obtain a 64B/65B code block.

Step 308: Demapping the 64B/65B code block to obtain each FC service signal, and sending each FC service signal to the FC service receiving end.

Because a label is added to GFP frames one by one, it may be unnecessary to delimit a frame header for each GFP frame when the WAN receiving end recovers the GFP frame in the Ethernet payload. In this way, when the FC service receiving end receives the GFP frame, the core header error check may be simplified, without the necessity of frame delimitation.

Step 309: The FC service receiving end receives the FC services from the FC service transmitting end.

With the development of packet transport network technologies, the PBT network may be another choice for packet transmission in the near future in addition to the MPLS network. In the PBT network, B-MAC+B-VLAN are used to identify the transport path. When FC services are transmitted, an Ethernet B-MAC and an Ethernet B-VLAN ID are added to each GFP frame, and then a PBT type field is added. This can implement the transmission of GFP frames in the PBT network. Except the step of adding transport path IDs, the transmission process in the PTB network is similar to that in the MPLS network, and will not be further described.

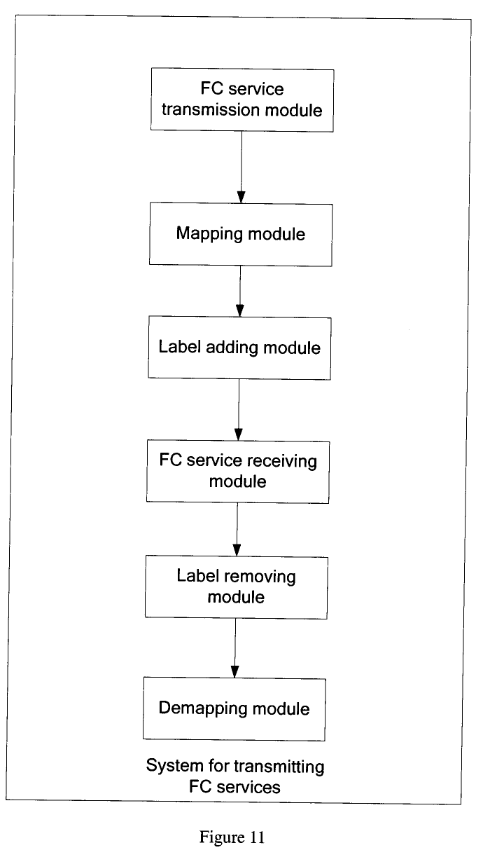

As shown in FIG. 11, an embodiment of the present disclosure provides a system for transmitting FC services. The system includes an apparatus for transmitting FC services and an apparatus for receiving FC services, where the apparatus for transmitting FC services includes an FC service transmission module, a mapping module, and a label adding module, and the apparatus for receiving FC services includes an FC service receiving module, a label removing module, and a demapping module.

The FC service transmission module is adapted to send an FC service to the mapping module.

The mapping module is adapted to map the received FC service to a transparently encapsulated code block, and send the transparently encapsulated code block to the label adding module.

The label adding module is adapted to add a transport channel label to the received transparently encapsulated code block, and load the transparently encapsulated code block into an Ethernet payload for transmission in the packet transport network.

The FC service receiving module is adapted to receive the Ethernet payload transmitted in the packet transport network, and send the received Ethernet payload to the label removing module.

The label removing module is adapted to remove the transport channel label from the received Ethernet payload, extract the transparently encapsulated code block, and send it to the demapping module.

The demapping module is adapted to demap the received transparently encapsulated code block to obtain the FC service.

Although the invention has been described through some exemplary embodiments, the invention is not limited to such embodiments. It is apparent that those skilled in the art can make various modifications and variations to the invention without departing from the spirit and scope of the invention. The invention is intended to cover the modifications and variations provided that they fall in the scope of protection defined by the following claims or their equivalents.

What is claimed is:

1. A method for transmitting fiber channel (FC) services, comprising:
mapping, by an FC service transmitting end, an FC service to a transparently encapsulated code block;
adding a transport channel label to the transparently encapsulated code block; and loading the transparently encapsulated code block into an Ethernet payload for transmission in a packet transport network.

2. The method of claim 1, wherein the process of mapping an FC service to a transparently encapsulated code block comprises:
performing, by the FC service transmitting end, 64B/65B encoding on the FC service to form a 64B/65B code block;
encapsulating in a Generic Framing Procedure (GFP), the 64B/65B code block as a payload information field to form a GFP frame; and
mapping the GFP frame to the transparently encapsulated code block.

3. The method of claim 1, wherein the process of mapping an FC service to a transparently encapsulated code block comprises:
encoding, by the FC service transmitting end, the FC service to form a 64B/65B code block; and
mapping the 64B/65B code block to the transparently encapsulated code block.

4. The method of claim 2, wherein the process of adding a transport channel label to the transparently encapsulated code block and loading the transparently encapsulated code block into an Ethernet payload for transmission in the packet transport network comprises:
adding a Multiple Protocol Label Switching (MPLS) label to the transparently encapsulated code block and inserting a stack bottom flag to form an MPLS frame; and
loading the MPLS frame into an Ethernet payload for transmission in an MPLS network.

5. The method of claim 4, wherein after the MPLS label is added to the transparently encapsulated code block and before the stack bottom flag is inserted, the process further comprising:
inserting a general interconnection indication field.

6. The method of claim 1, wherein the packet transport network is an MPLS network or a provider backbone transport (PBT) network.

7. A method for transmitting fiber channel (FC) services, comprising:
receiving, by an FC service receiving end, an Ethernet payload from a packet transport network, and removing a transport channel label from the Ethernet payload to obtain a transparently encapsulated code block; and
demapping the obtained transparently encapsulated code block to obtain an FC service.

8. The method of claim 7, wherein when the packet transport network is a Multiple Protocol Label Switching (MPLS) network, the process comprising:
extracting and processing, by the FC service receiving end, a stack bottom flag;
extracting an MPLS frame from the Ethernet payload;
removing a label from the MPLS frame to obtain the transparently encapsulated code block; and
demapping the obtained transparently encapsulated code block to obtain an FC service signal.

9. The method of claim 8, wherein after the MPLS frame is extracted from the Ethernet payload and before the label of the MPLS frame is removed, the process further comprising:
extracting a general interconnection indication field, and processing a sequence number.

10. An apparatus for transmitting FC services, comprising:
an FC service transmission module, adapted to transmit an FC service;
a mapping module, adapted to receive the FC service from the FC service transmission module, map the FC service to a transparently encapsulated code block, and transmit the transparently encapsulated code block; and
a label adding module, adapted to receive the transparently encapsulated code block from the mapping module, add a transport channel label to the transparently encapsulated code block, and load the transparently encapsulated code block to an Ethernet payload for transmission in a packet transport network.

11. The apparatus of claim 10, further comprising:
an FC service receiving module, adapted to receive an Ethernet payload transmitted in a packet transport network, and forward the Ethernet payload;
a label removing module, adapted to receive the Ethernet payload from the FC service receiving module, remove the transport channel label from the Ethernet payload, and extract a transparently encapsulated code block for transmission; and
a demapping module, adapted to receive the transparently encapsulated code block from the label removing module, and demap the transparently encapsulated code block to obtain an FC service.
